(19) United States
(12) Patent Application Publication
(10) Pub. No.: US 2006/0086208 A1
(43) Pub. Date: Apr. 27, 2006

(54) Band saw blade setter with up-set and down-set

(76) Inventors: Art F. Gschwind SR., East Moriches, NY (US); Thomas W. Davies, West Sayville, NY (US)

Correspondence Address: E.J. Asbury III, Esq.;E.J. Asbury III, LLC, Suite 500, 3330 Cumberland Blvd., Atlanta, GA, 30339-5985, US

(21) Appl. No.: 10/974,896

(22) Filed: Oct. 27, 2004

(51) Int. Cl. B23D 63/04

(52) U.S. Cl. 76/58

(57) ABSTRACT

A setter for setting the teeth of a band saw blade. The setter has at least one up-set tool bit configured to increase the set of a blade tooth. The distance between the up-set tool bit and the blade tooth is adjustable by a first threaded member. The setter also has at least one down-set tool bit configured to decrease the set of the blade tooth. The distance between the down-set tool bit and the blade tooth is adjustable by a second threaded member. A mechanical linkage is configured to move the at least one up-set tool bit toward the blade tooth, and also configured to move the at least one down-set tool bit toward the blade tooth during a set operation. Wherein during the set operation, a clamping linkage clamps the blade within the setter, and the at least one up-set tool bit is driven toward the blade tooth of the clamped band saw blade by the mechanical linkage, and the at least one down-set tool bit is driven toward the opposing side of the blade tooth of the clamped band saw blade by the mechanical linkage. The distance between the at least one up-set tool bit and the blade tooth is adjusted via the first threaded member such that during the set operation, the up-set tool bit applies a first up-set displacement to the blade tooth. The distance between the at least one down-setting tool bit and the blade tooth is adjusted via the second threaded member such that during the set operation, the down-set tool bit applies a first down-set displacement to the blade tooth. The mechanical linkage of the setter comprising a follower arm and cam design.

### BACKGROUND OF THE INVENTION

1. Field of the Invention

The present invention generally relates to an improved manually operated band saw blade setter. More particularly, the present invention relates to a dual tooth band saw blade setter with the capability to both up-set and down-set the blade teeth and with an improved mechanical linkage for applying the set displacement to the blade teeth.

2. Description of the Related Art

Band saws are used for a broad range of range of cutting tasks from dimension rough lumber to cutting intricate and delicate shapes. A band saw blade is a continuous loop of flexible metal with cutting teeth on one edge. The teeth of the band saw blade are displaced to each side of the plane of the blade. The displacement of each band saw tooth from the plane of the blade is known as the set of the tooth. This displacement provides clearance for the blade body to pass through the object being cut and aids in the removal of the waste material from the saw kerf. Pairs of successive teeth along the length of the band saw blade are set to opposing sides of the plane of the blade. The opposing off-set provides equal clearance and dynamic forces on each side of the blade as it passes thru the material to be cut and aids the blade in tracking in a straight line through the cut.

Increasing the set of a tooth increases the material removed by the tooth and widens the saw kerf. This set direction is known as up-setting the blade tooth. Reducing the set of a blade tooth reduces the material removed by the tooth and narrows the saw kerf. This set direction is known as down-setting the tooth. In practice, it is desirable to precisely reset the amount of off-set of each cutting tooth along the blade periphery from time to time during the blade service life. A band saw blade with too much set on each cutting tooth removes more material than necessary, requires more power to drive, and will dull more quickly. A blade with too little set will bind and burn in the saw cut kerf.

To re-set the teeth of a band saw blade, the blade is held in a fixed position and each tooth is displaced a given distance to one side or the other of the blade. The elasticity of the blade material results in each tooth springing back slightly from the full displaced position. Therefore, it is required to displace each tooth slightly more than the desired final set during the re-set operation. It is desirable to achieve a consistent and precise set on each tooth of the blade during the re-set operation despite the elastic properties of the blade material. A mechanical advantage is also desirable to aid the operator in repeatedly bending successive blade teeth. Moreover, prior art setters only applied an up-set to each band saw blade tooth. A tooth that was up-set to far, was not corrected by down-setting during the re-setting operation. Thus in the prior art, the amount of up-set of each blade tooth was controlled to a minimum value, but any tooth exceeding that value was not appropriately down-set.

Accordingly, there is a need for a manually operated setter for quickly and reliably achieving a uniform set on each tooth of a band saw blade, while addressing both the up-set of the teeth, and the down-set of the teeth, with a minimum of operator fatigue.

### SUMMARY OF THE INVENTION

The disadvantages of the prior art are overcome by the present invention which, in one aspect, is a setter for setting the teeth of a band saw blade. The setter having a clamping linkage for clamping the band saw blade in the setter during a set operation. The band saw blade having multiple teeth on one edge of the blade.

The setter has at least one up-set tool bit configured to increase the set of a blade tooth. The distance between the up-set tool bit and the blade tooth is adjustable by a first threaded member. The setter also has at least one down-set tool bit configured to decrease the set of the blade tooth. The distance between the down-set tool bit and the blade tooth is adjustable by a second threaded member. A mechanical linkage is configured to move the at least one up-set tool bit toward the blade tooth, and also configured to move the at least one down-set tool bit toward the blade tooth during the set operation. Wherein during the set operation, the clamping linkage clamps the blade within the setter, and the at least one up-set tool bit is driven toward the blade tooth of the clamped band saw blade by the mechanical linkage, and the at least one down-set tool bit is driven toward the opposing side of the blade tooth of the clamped band saw blade by the mechanical linkage.

In another aspect, the distance between the at least one up-set tool bit and the blade tooth is adjusted via the first threaded member such that during the set operation, the up-set tool bit applies a first up-set displacement to the blade tooth.

In yet another aspect, the distance between the at least one down-setting tool bit and the blade tooth is adjusted via the second threaded member such that during the set operation, the down-set tool bit applies a first down-set displacement to the blade tooth.

In yet another aspect, the distance between the at least one up-set tool bit and the blade tooth is adjusted via the first threaded member such that during the set operation, the up-set tool bit applies a first up-set displacement to the blade tooth. And also, the distance between the at least one down-set tool bit and the blade tooth is adjusted via the second threaded member such that during the set operation, the down-set tool bit applies a first down-set displacement to the blade tooth.

In yet another aspect, the setter has a second up-set tool bit, configured to increase the set of a second blade tooth of the band saw blade, and a second down-set tool bit, configured to decrease the set of the second blade tooth of the band saw blade during the set operation. The first tooth and the second tooth may be adjacent on the band saw blade. The at least one down-set tool bit may be comprised of a non-ferrous material and the non-ferrous material may be a plastic.

In yet another aspect, the clamping linkage for clamping the band saw blade in the setter may be a first clamp plate adjacent one side of the band saw blade and an opposing second clamp plate adjacent the opposite side of the band saw blade. During a set operation, the first clamp plate and second clamp plate are moved toward the band saw blade by the mechanical linkage, and clamp the band saw blade between the first clamp plate and the second clamp plate.

In yet another aspect, the present invention is a setter for setting the teeth of a band saw blade. The band saw blade has multiple teeth on one edge of the blade. The setter has a base member and a mechanical linkage configured to apply a set displacement to at least one tooth of the blade during a set operation. The setter also has a clamping linkage for clamping the band saw blade in the setter during the set operation.

The mechanical linkage of the setter may be a first pivot on the base member with a first jaw pivotably mounted to the base member on the first pivot. The first jaw extends to an upper portion above the first pivot and extends to a lower portion below the first pivot. The lower portion of the first jaw has a first cam surface thereon. The mechanical linkage has a second pivot on the base member and a second jaw pivotably mounted to the base member on the second pivot. The second jaw extends to an upper portion above the second pivot and a lower portion below the second pivot. The lower portion of the second jaw has a second cam surface thereon. The linkage also has a third pivot on the base member below the first pivot and below the second pivot and between the first jaw lower portion and the second jaw lower portion. A lever member is pivotably mounted to the base member on the third pivot. The lever member has a first follower arm extending to one side of the third pivot and a second follower arm extending to the other side of the third pivot. The first follower arm has a first outer surface, and the second follower arm has a second outer surface. The lever member also has a lever handle extending to one side of the third pivot.

The mechanical linkage also has at least one up-set tool bit configured to increase the set of the blade tooth. The up-set tool bit is affixed to the upper portion of the first jaw, and the distance between the up-set tool bit and the blade tooth is adjustable by a first threaded member. During the set operation, a rotation of the lever member forces the first outer surface of the first follower arm to contact the first cam surface on the first jaw, and forces the second outer surface of the second follower arm to contact the second cam surface on the second jaw. The follower arm contact forces the lower portion of the of the first jaw and the lower portion of the second jaw to rotate outward away form the third pivot, which forces the upper portion of the first jaw and the upper portion of the second jaw to rotate inward toward the band saw blade. The first jaw rotation forces the at least one up-set tool bit to be driven toward the blade tooth of the clamped band saw blade. The distance between the at least one up-set tool bit and the blade tooth is adjusted via the first threaded member such that during the set operation, the up-set tool bit applies a first up-set displacement to the blade tooth.

In yet another aspect, the first outer surface of the first follower arm may be a bearing rotateably mounted to the first follower arm and the second outer surface of the second follower arm may be a bearing rotateably mounted to the second follower arm. The first and second cam surfaces may be a wear plate affixed to the first jaw at the first cam surface and a second wear plate affixed to the second jaw at the second cam surface. The setter may also have a spring element which urges the lower portion of the first jaw and the lower portion of the second jaw to rotate inward toward the third pivot. The mechanical linkage may also have at least one down-set tool bit configured to decrease the set of the blade tooth. The down-set tool bit may be affixed to the upper portion of the second jaw and the distance between the down-set tool bit and the blade tooth may be adjustable by a second threaded member. The rotation inward of the upper portion of the second jaw toward the band saw blade may force the at least one down-set tool bit to be driven toward the blade tooth of the clamped band saw blade. The distance between the at least one down-set tool bit and the blade tooth may be adjusted via the second threaded member such that during the set operation, the down-set tool bit applies a first down-set displacement to the blade tooth.

In yet another aspect, the present invention is a method for setting the teeth of a band saw blade. The band saw blade has multiple teeth on one edge of the blade, and the teeth may be cutting teeth or raker teeth. The band saw blade is placed in a setter. The setter has a mechanical linkage configured to apply a set displacement to at least one cutting tooth of the blade during a set operation. The setter also has a clamping linkage for clamping the band saw blade in the setter during the set operation and has at least one up-set tool bit configured to increase the set of the cutting tooth The distance between the up-set tool bit and the cutting tooth is adjustable by a first threaded member. The setter also has at least one down-set tool bit configured to decrease the set of the cutting tooth. The distance between the down-set tool bit and the cutting tooth is adjustable by a second threaded member. The distance between the at least one down-setting tool bit and the cutting tooth is adjusted via the second threaded member such that during a set operation, the down-set tool bit applies a first down-set displacement to the cutting tooth. A set operation is then applied to the blade, wherein the at least one down-set tool bit is driven toward the cutting tooth of the clamped band saw blade and applies the first down-set displacement to the cutting tooth. The band saw blade is then rotated within the setter and the set operation repeated until all cutting teeth of the band saw blade receive the first down-set displacement.

The distance between the at least one down-setting tool bit and the cutting tooth is then adjusted via the second threaded member such that during a set operation, the down-set tool bit does not contact the cutting tooth. The distance between the at least one up-setting tool bit and the cutting tooth is then adjusted via the first threaded member such that during a set operation, the up-set tool bit applies a first up-set displacement to the cutting tooth. A set operation is then applied to the blade, wherein the at least one up-set tool bit is driven toward the cutting tooth of the clamped band saw blade and applies the first up-set displacement to the cutting tooth. The band saw blade is then rotated within the setter and the set operation is repeated until all blade cutting teeth receive the first up-set displacement thereby setting the band saw blade.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESPCRIPTION OF THE DRAWINGS

FIG. 1 is a side view of the band saw blade setter illustrating a band saw blade positioned in the setter, the height adjustment of the blade, and the blade advance mechanism.

FIG. 2 is a perspective view of a section of a band saw blade cutting into an object illustrating the set of the blade teeth and the kerf cut into the object.

FIG. 3 is a perspective view of the band saw blade setter of FIG. 1 illustrating a band saw blade positioned in the setter, the setter mechanical linkage, and the tooling bits for displacing the blade teeth.

FIG. 4 is a front view of the band saw blade setter of FIG. 1 illustrating the mechanical linkage with the jaws of the setter open and the linkage for clamping the blade in the setter.

FIG. 5 is a front view of the band saw blade setter of FIG. 1 illustrating the mechanical linkage with the jaws of the setter closed and particularly showing the operation of the cam and follower.

FIG. 6 is a perspective view of the jaw portion of the band saw blade setter of FIG. 1 illustrating the up-set and down-set tooling bits, the tooling bit adjustment screws, and the blade teeth.

FIG. 7 is a perspective view of the jaw portion of the band saw blade setter of FIG. 1 illustrating up-setting a pair of blade teeth.

FIG. 8 is a perspective view of the jaw portion of the band saw blade setter of FIG. 1 illustrating down-setting a pair of blade teeth.

FIG. 9 is a perspective view of the jaw portion of the band saw blade setter of FIG. 1 illustrating simultaneously up-setting and down-setting a pair of blade teeth.

FIG. 10 is a side view of the band saw blade setter of FIG. 1 illustrating the blade advance mechanism at the start of a blade advance.

FIG. 11 is a side view of the band saw blade setter of FIG. 1 illustrating the blade advance mechanism at the end of a blade advance, and illustrating the forward motion of the blade.

### DETAILED DESCRIPTION OF THE INVENTION

The invention may be embodied in a dual tooth setter with up-set and down-set capability. Operation of the setter handle moves a mechanical linkage which clamps the band saw blade in the setter and moves the setter jaws toward the band saw teeth from each side. This operation is referred to herein as a set operation. Affixed to each jaw is an up-set and down-set tool bit. The position of the up-set and down-set tool bits relative to the setter jaws may be adjusted such that an up-set, a down-set, or both an up-set and down-set tool bit contacts the band saw teeth. The tool bits then deliver a precise and controlled set displacement to the band saw teeth during the set operation.

The invention may also be embodied in a dual tooth setter with up-set and down-set capability which includes a mechanical linkage with a follower arm and cam surface. A setter handle is used to operate the mechanical linkage of the setter. The use of a follower arm and cam design allows for a variable deflection curve to be attained at the tool bits per each increment of rotation of the setter handle. The design allows for a high degree of movement of the tool bits during the initial rotation of the setter handle. However, as the setter handle reaches the bottom of the set stroke, the movement of the tool bits is progressively reduced by the cam profile. Due to the cam profile, the mechanical advantage of the setter handle when applying force to the blade teeth becomes extremely high at the end of the handle stroke. The use of a cam surface thus allows for smooth and controlled application of force upon the blade teeth and the generation of high forces upon the blade teeth during the set operation. The use of the follower arm and cam design also reduces operator fatigue while increasing the accuracy of set delivered to the blade teeth.

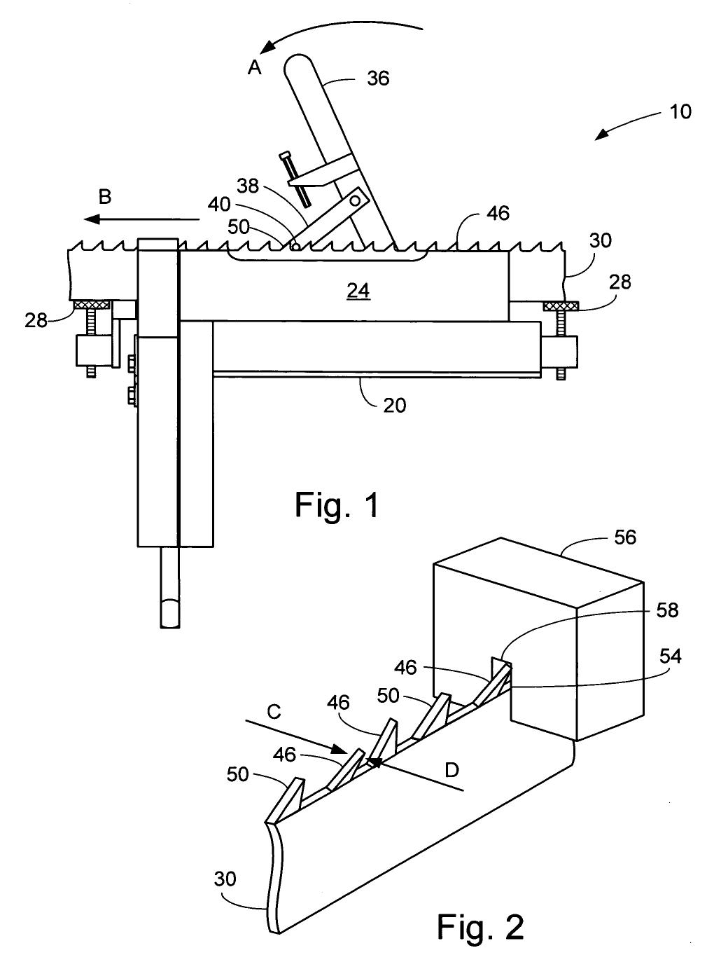

With reference to the figures in which like numerals represent like elements throughout, FIG. 1 is a side elevation of the band saw blade setter 10. The setter 10 has a base 20 and blade clamp plates 24 for securely holding the blade during a setting operation. The band saw blade 30 is positioned in the setter 10 between the blade clamp plates 24 and rests upon blade elevation screws 28. The blade elevation screws 28 are threaded into the base 20 and allow adjustment of the height of the band saw blade 30 relative to the setter 10. Blade advance lever 36 is pivotably mounted to base 20 and is used to move the blade 30 relative to the setter 10 after each set operation. Push paw 38 has a push pin 40 at one end and is pivotably mounted to blade advance lever 36 at the other end. As the blade advance lever 36 is moved in the direction of arrow A, the push pin 40 pushes against the gullet of a blade raker tooth 50 to advance the blade 30 relative to the setter 10 in the direction of arrow B.

As shown in FIG. 2, a typical band saw blade 30 has a first blade cutting tooth 46 and is off-set to one side of the plane of the blade 30 and a second following cutting tooth 46 that is off-set to the other side of the plane of the blade 30. A third raker tooth 50 is positioned after the first and second teeth and is not off-set relative to the plane of the blade 30, but rather extends straight up from the blade base. In operation, the blade cutting teeth 46 pass through a material to be cut creating a saw kerf 54 in the object 56. The first cutting tooth 46 removes material form one side of the saw kerf, the following second cutting tooth 46 removes additional material from the opposing side of the saw kerf. The raker tooth 50 removes any material remaining in the kerf 54 after the two leading cutting teeth 46 pass and flattens the leading edge 58 of the saw kerf 54. A typical band saw blade is comprised of sets of the two cutting teeth 46 above and the following raker tooth 50 repeated around the periphery of the blade.

As further shown in FIG. 2, increasing the off-set of a blade cutting tooth 46 relative to the blade body 30, shown in the direction of arrow C for cutting tooth 46, increases the material removed by the blade cutting tooth 46 and widens the saw kerf 54. This off-set is known as up-setting the blade tooth. Reducing the off-set of the blade cutting tooth 46 relative to the blade body 30, shown in the direction of arrow D for cutting tooth 46, reduces the material removed by the blade cutting tooth 46 and narrows the saw kerf 54, and is known as down-setting the tooth. In operation, it is desirable to precisely control the amount of off-set of each cutting tooth 46 along the blade 30 periphery. A blade 30 with too much off-set on each cutting tooth 46 removes more material than necessary, requires more power to drive, and will dull more quickly. A blade 30 with too little off-set will bind and burn in the saw cut kerf 54.

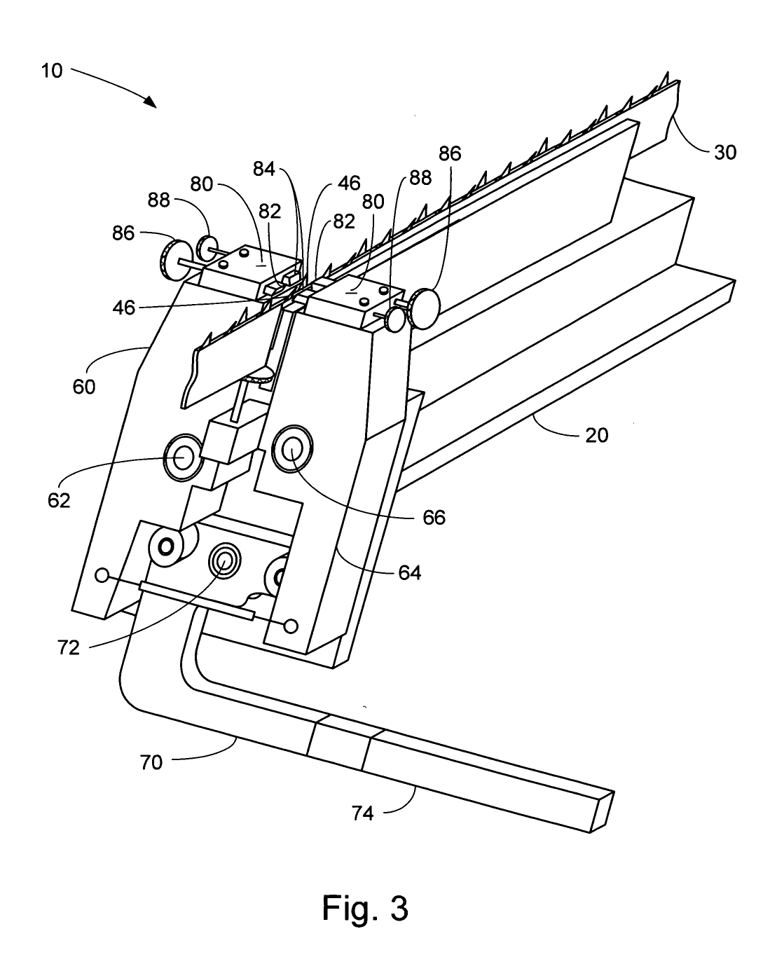

FIG. 3 is a perspective view of the setter 10. The setter 10 has a left jaw 60 pivotably attached to the base 20 at a pivot point 62 and a right jaw 64 pivotably attached to the base 20 at a pivot point 66. Lever arm 70 is also pivotably attached to base 20 at a pivot point 72. Extension handle 74 increases the length of the lever arm 70. Tool bit guide blocks 80 are affixed to the upper surface of left jaw 60 and right jaw 64. Each tool bit guide block 80 slideably engages one up-set tool bits 82 and one down-set tool bit 84, the tool bits being spaced apart to allow the setting of two adjacent teeth. The opposing tool bit guide blocks 80 house opposing up-set tool bits 82 and down-set tool bits 84 at each cutting tooth 46 location. An up-set adjustment screw 86 engages each tool bit guide block 80 and forces each up-set tool bit 82 out of the guide block and toward the band saw blade 30. A down-set adjustment screw 88 engages each tool bit guide block 80 and forces each down-set tool bit 84 out of the guide block and toward the band saw blade 30. In this manner, one up-set tool bit 82 and one down-set tool bit 84 approaches each of two successive cutting teeth 46 of the band saw blade 30 during a set operation.

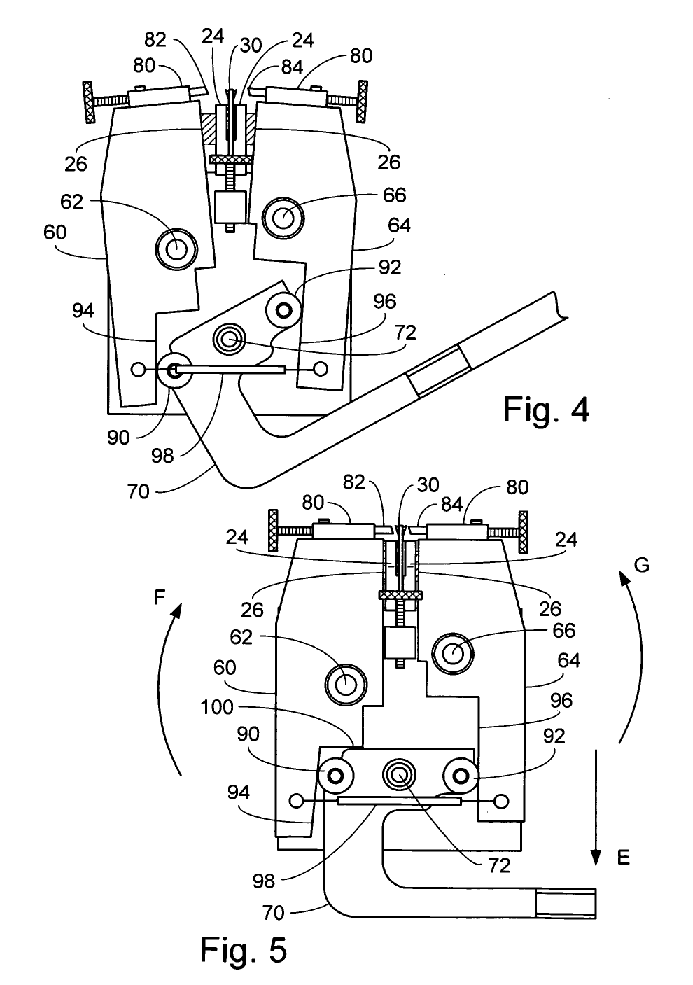

As best shown in FIG. 4, the setter 10 has a mechanical linkage for applying the up-set and down-set to the blade 30. The lever arm 70 is shown in a raised position and has rotating bearings 90 and 92 mounted at the outer portions thereof and to either side of the lever pivot point 72. The left jaw 60 has a cam surface 94 for engaging the rotating bearing 90 and right jaw 64 has a cam surface 96 for engaging the rotating bearing 92. The outer portions of the lever arm 70 comprise follower arms which remain in contact with the cam surfaces 94, 96 in operation. The rotating bearings 90 and 92 reduce the friction encountered between the follower arms and cam surfaces 94, 96. An extension spring 98 urges the left jaw 60 to rotate counter clockwise and remain in contact with the rotating bearing 90 at the cam surface 94 and also urges the right jaw 64 to rotate clockwise and remain in contact with the rotating bearing 92 at the cam surface 96.

As further shown in FIG. 4, a blade clamp plate 24 is pivotably affixed to the base 20 and extends along either side of the blade 30. The left jaw 60 and right jaw 64 are positioned on each outside surface of the clamp plates 24. A spring element 26 is positioned between the each clamp plate 24 and jaw 60, 64.

As shown in FIG. 5, during a set operation, as the lever arm 70 is forced down in the direction of arrow E, the lever arm 70 pivots about the pivot point 72 and the rotating bearings 90, 92 are forced into the cam surfaces 94, 96 of the jaws 60, 64. The rotating bearings 90, 92 then force the lower portion of the jaws 60, 64 apart. The left jaw 60 rotates about pivot point 62 clockwise in the direction of arrow F, and the right jaw 64 rotates about pivot point 66 counter-clockwise in the direction of arrow G. As the jaws 60, 64 rotate, the tool bit holders 80 mounted to the top of the jaws and up-set tool bits 82 and down-set tool bits 84 are driven toward the band saw blade 30 with great force. The maximum movement of the lever arm 70 and jaws 60, 64 is controlled by the lever arm 70 contacting the left jaw 60 at point 100. When the lever arm 70 contacts the left jaw 60 at point 100 no additional movement of the up-set tool bits 82, or down-set tool bits 84 toward the blade 30 is possible. In this manner, the movement of the up-set tool bits 82 and down-set tool bits 84 toward the blade cutting teeth 46 is precisely controlled.

As further shown in FIG. 5, the upper portion of the left jaw 60 and right jaw 64 move inward toward the blade 30 and compress the spring elements 26 against each clamp plate 24. The clamp plates 24 then firmly clamp the blade 30 firmly in the setter 10 during the set operation. The use of the spring elements 26 allows the setter to accommodate a range of blade 30 thicknesses while maintaining a positive clamping force on the blade. The jaws 60, 64, spring elements 26 and clamp plates 24 thus form a clamping linkage for clamping the band saw blade within the setter 10 during the set operation.

In one embodiment, the cam surfaces 94, 96 of the left jaw 60 and right jaw 64 are flat surfaces allowing ease of fabrication. The can surfaces 94, 96 are angled to provide for uniform displacement of each tool bit 82, 84 as the jaws 60, 64 rotate. Wear plates are affixed to the jaws 60, 64 at each cam surface 94, 96, and positioned between the jaws 60, 64 and the rotating bearings 90, 92. The wear plates absorb the high contact forces generated at the cam surfaces 94, 96 between the rotating bearings 90, 92 and the jaws 60, 64 and may be replaced after extended operation of the setter 10. In an alternative embodiment, the cam surfaces 94, 96 may be parabolic or curved to provide a desired deflection at the tool bits 82, 84 per unit of lever arm 70 movement. In another alternative embodiment, the outer portions of lever arm 70 directly contact the cam surfaces 94, 96 of the jaws 60, 64. The rotating bearings 90, 92 are eliminated and in operation, the outer portion of the lever arm 70 slides along the cam surfaces 94, 96.

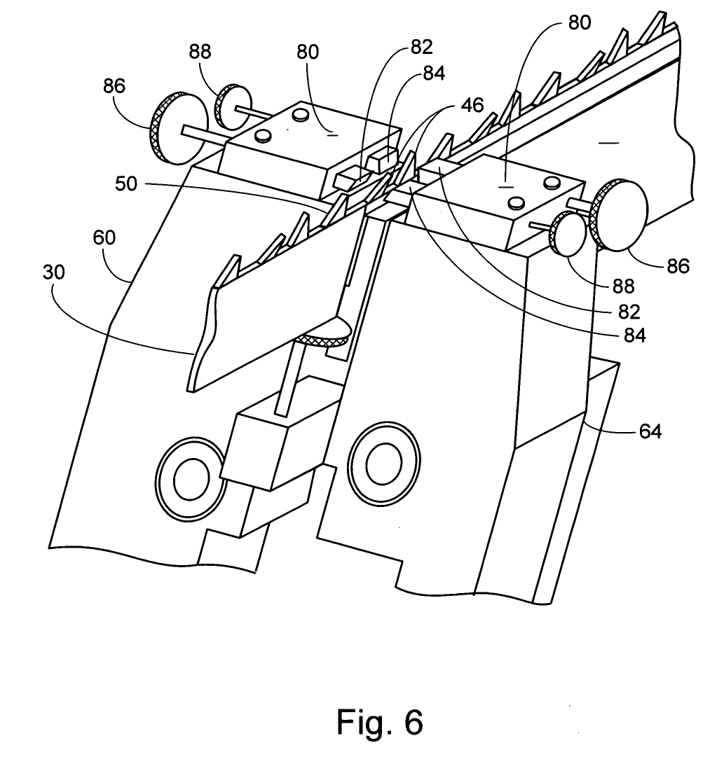

As shown in FIG. 6, during a set operation, the upper portion of the jaws 60, 64 move towards one another. The tool bit guide blocks 80 mounted to the respective jaws 60, 64 each house an up-set tool bit 82 and down-set tool bit 84. Opposing tool bits 82, 84 approach a single blade cutting tooth 46 from each side. A second pair of opposing tool bits 82, 84 approach another adjacent cutting tooth 46 on the blade 30. As shown in FIG. 6, each up-set adjusting screw 86 and down-set adjusting screw 88 is positioned so that the up-set tool bits 82 and down set tool bits 84 are retracted and do not contact the cutting teeth 46 of the blade 30.

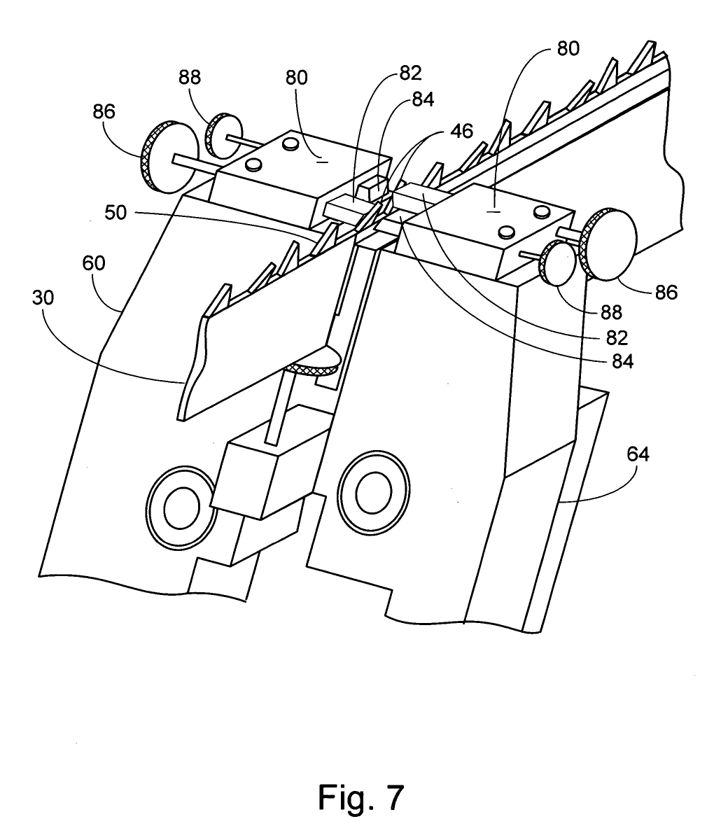

As shown in FIG. 7, prior to a set operation, the setter may be configured for an up-set operation. The down-set tool bit adjustment screws 88 may be retracted from the tool bit guide blocks 80 and each down-set tool bit 84 may be retracted back into the tool bit guide block. The up-set tool bit adjustment screws 86 may then be screwed into the tool bit guide blocks 80 so as to force each up-set tool bit 82 a precise distance out of the tool bit guide block. The use of two up-set tool bits 82 on opposing sides of the blade 30 allow for the up-set of two adjacent cutting teeth 46 to be applied at the same time. In this configuration, during a set operation each up-set tool bit 84 contacts a blade cutting tooth 46 and displaces it a precise distance away from the plane of the blade 30. The amount of up-set deflection applied to each blade cutting tooth 46 may be precisely controlled by extending or retracting the finely threaded up-set tool bit adjustment screws 86. The blade 30 may then be advanced in the setter a distance equal to 3 blade teeth, and the up-set operation repeated to sets of adjacent cutting teeth 46 around the periphery of the blade 30 while applying no set to each raker tooth 50.

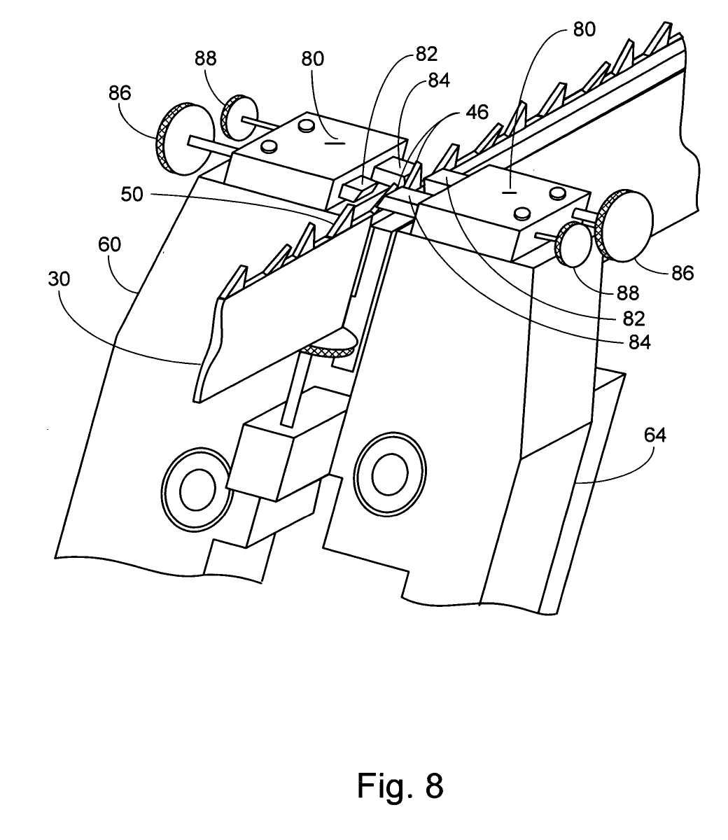

As best shown in FIG. 8, prior to another set operation, the setter may be configured for a down-set operation. The up-set tool bit adjustment screws 86 may be retracted from the tool bit guide blocks 80 and each up-set tool bit 82 may be retracted back into the tool bit guide block. The down-set tool bit adjustment screws 88 may be screwed into the tool bit guide blocks 80 so as to force each down-set tool bit 84 a precise distance out of the tool bit guide block. The use of two down-set tool bits 84 on opposing sides of the blade 30 allow for the down-set of two adjacent cutting teeth 46 to be applied at the same time. In this configuration, during a set operation each down-set tool bit 84 contacts a blade cutting tooth 46 and displaces it a precise distance in the direction of the plane of the blade 30. The amount of down-set deflection applied to each blade cutting tooth 46 may be precisely controlled by extending or retracting the finely threaded down-set tool bit adjustment screws 88. The blade 30 may then be advanced in the setter a distance equal to 3 blade teeth, and the down-set operation repeated to sets of adjacent cutting teeth 46 around the periphery of the blade 30 while applying no set to each raker tooth 50.

The outside edge of the blade cutting tooth 46 is the primary cutting edge which engages the material to be cut. During the down-set operation, the down-set tool bit 84 contacts and applies force to this outside cutting edge of the tooth 46. In order to preclude dulling or damaging the cutting edge of the blade cutting tooth 46, a material softer than that of the blade tooth is desirable for the down-set tool bit 84. In one embodiment, the material of the down-set tool bit 84 may comprise a plastic such as is marketed under the tradename Delrin® by the Dupont Corporation. Those skilled in the art will appreciate that other materials may also be used to fabricate the down-set tool bit such as soft copper, soft brass or various rubbers and urethanes.

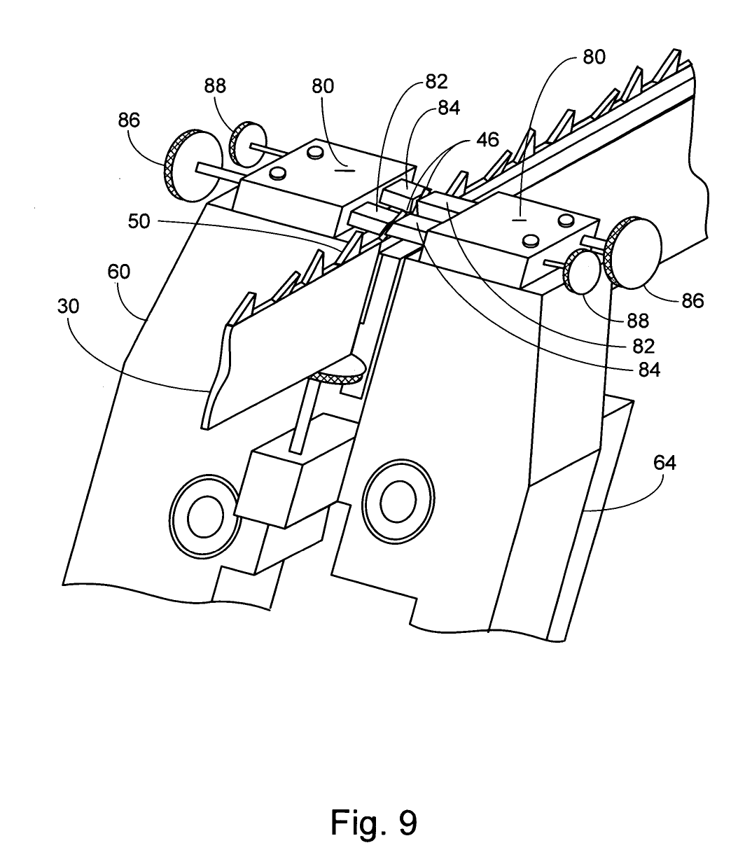

As shown in FIG. 9, the setter may also be configured to apply both an up-set and down-set to adjacent teeth during the same set operation. In this configuration, the up-set tool bit adjustment screws 86 and the down set adjustment screws 88 are screwed into the tool bit guide blocks 80 so as to force each up-set tool bit 82 and down-set tool bit 84 out of the tool bit guide block. During a set operation both the up-set tool bit 82 and down-set tool bit 84 contacts a blade cutting tooth 46 on opposing sides. The blade cutting tooth 46 is then clamped between the up-set tool bit 82, and the down-set tool bit 84 during the set operation. This configuration is useful for rapidly up-setting a blade 30 while insuring no cutting teeth 46 have previously been up-set substantially more than the desired amount. This condition may occur when a single tooth 46, or a series of teeth on a blade become distorted in operation.

The configuration shown in FIG. 9 may also be useful to control the exact profile of the set of the cutting tooth 46 from the base or gullet of the tooth, to the tooth tip. The profile of interest is the shape of the tooth when viewed along the axis of the blade. For example, in operation some cutting teeth 46 may become substantially up-set at the tip, but the amount of up-set may not increase progressively from the base of the tooth to the tip. If only a down-set operation were performed on such a tooth 46, the distorted tip of the tooth may be place in the proper position, but the body of the tooth would not have the desired progressively increasing set. Clamping such a distorted tooth 46 between the up-set tool bit 82 and down-set tool bit 84 will reshape the tooth profile and partially restore the desired progressively increasing tooth set.

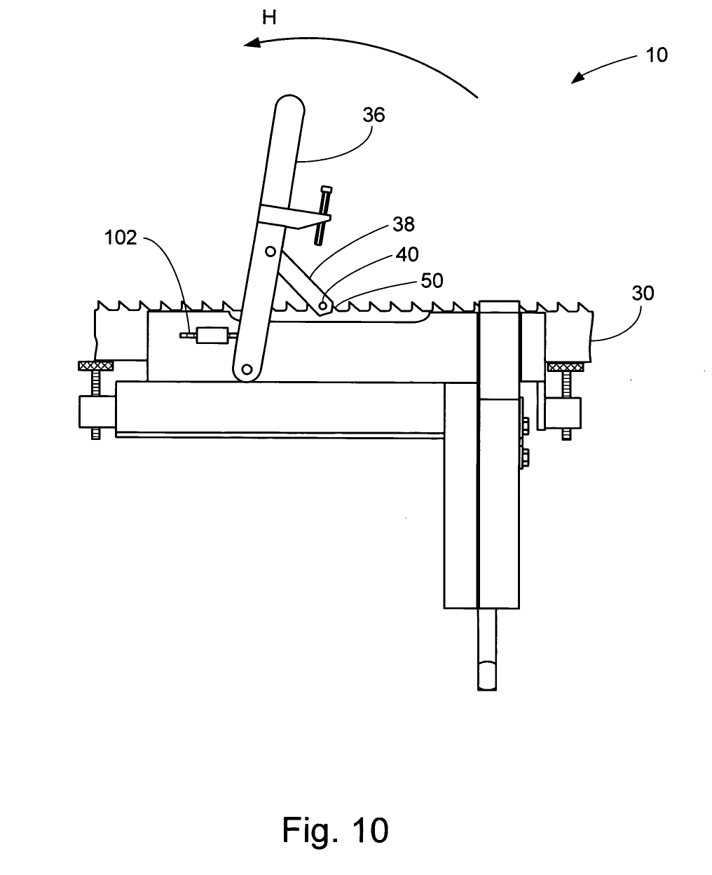

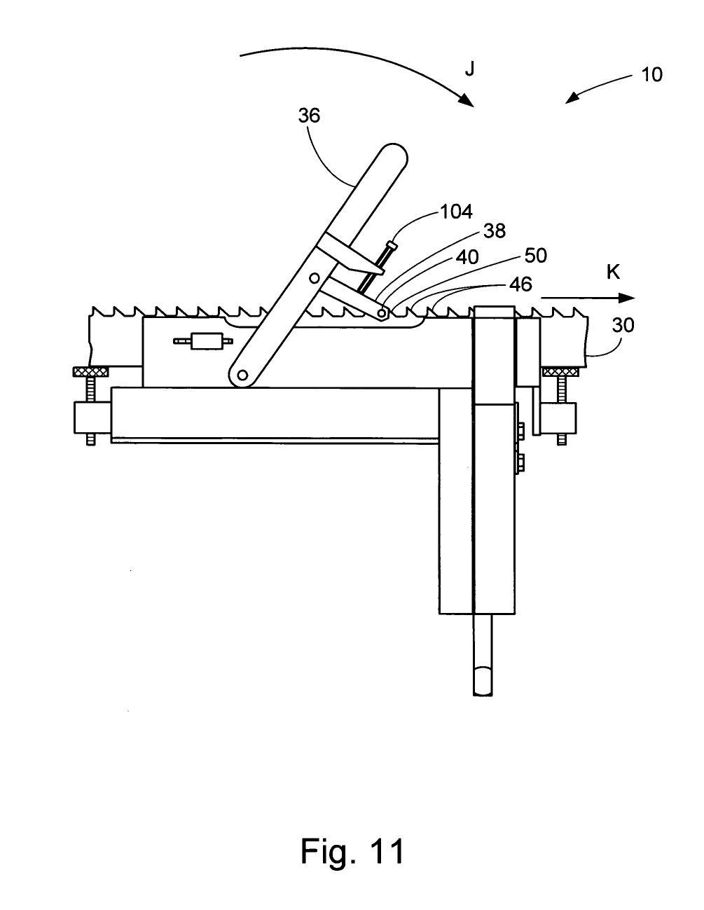

Advancing the blade 30 in the setter 10 after a set operation is best shown in FIGS. 10 and 11. In FIG. 10, at the conclusion of a set operation the blade advance lever 36 is moved in the direction of arrow H. In this position, the base of the advance lever 36 strikes backstop adjusting screw 102. The push paw 38 rotates downward, and push pin 40 engages a raker tooth 50 on the blade 30. In operation, the backstop adjusting screw 102 is adjusted such that a pair of blade cutting teeth 46 are now in position to be set by the up-set tool bits 82 and down-set tool bits 84.

As shown in FIG. 11, to advance the blade after a set operation, the blade advance lever 36 is moved in the direction of arrow J. The push pin 40 pushes the blade 30 in the direction of arrow K until the push paw adjusting screw 104 strikes the blade adjusting lever 36, allowing no further movement of the blade advance lever 36 and blade 30. The push paw adjusting screw 104 is adjusted such that the blade 30 is moved a distance equal to the spacing of two cutting teeth 46 and one raker tooth 50. The movement of the blade 30 in three teeth increments ensures that the next pair of cutting teeth 46 are now in a position to be set and that the push pin 40 always acts upon a raker tooth 50.

Where there has been shown a preferred embodiment of the present invention, it is to be understood that certain changes may be made in the forms and arrangements of the elements and steps of the method setting a band saw blade without departing from the underlying spirit and scope of the invention.

What is claimed is:

1. A setter for setting the teeth of a band saw blade, the band saw blade having multiple teeth on one edge of the blade, the setter also having a clamping linkage for clamping the band saw blade in the setter during a set operation, the setter further comprising:
at least one up-set tool bit configured to increase the set of a blade tooth, the distance between the up-set tool bit and the blade tooth being adjustable by a first threaded member;
at least one down-set tool bit configured to decrease the set of the blade tooth, the distance between the down-set tool bit and the blade tooth being adjustable by a second threaded member;
a mechanical linkage configured to move the at least one up-set tool bit toward the blade tooth, and configured to move the at least one down-set tool bit toward the blade tooth during the set operation; and
wherein during the set operation, the clamping linkage clamps the blade within the setter, and the at least one up-set tool bit is driven toward the blade tooth of the clamped band saw blade by the mechanical linkage, and the at least one down-set tool bit is driven toward the opposing side of the blade tooth of the clamped band saw blade by the mechanical linkage.

2. The setter of claim 1, wherein the distance between the at least one up-set tool bit and the blade tooth is adjusted via the first threaded member such that during the set operation, the up-set tool bit applies a first up-set displacement to the blade tooth.

3. The setter of claim 1, wherein the distance between the at least one down-setting tool bit and the blade tooth is adjusted via the second threaded member such that during the set operation, the down-set tool bit applies a first down-set displacement to the blade tooth.

4. The setter of claim 1, wherein the distance between the at least one up-set tool bit and the blade tooth is adjusted via the first threaded member such that during the set operation, the up-set tool bit applies a first up-set displacement to the blade tooth; and
the distance between the at least one down-set tool bit and the blade tooth is adjusted via the second threaded member such that during the set operation, the down-set tool bit applies a first down-set displacement to the blade tooth.

5. The setter of claim 1, further comprising a second up-set tool bit, configured to increase the set of a second blade tooth of the band saw blade, and a second down-set tool bit, configured to decrease the set of the second blade tooth of the band saw blade during the set operation.

6. The setter of claim 5, wherein the first tooth and the second tooth are adjacent on the band saw blade.

7. The setter of claim 1, wherein the at least one down-set tool bit is comprised of a non-ferrous material.

8. The setter of claim 7, wherein the at least one down-set tool bit is comprised of a plastic.

9. The setter of claim 1, wherein the clamping linkage for clamping the band saw blade in the setter comprises a first clamp plate adjacent one side of the band saw blade and an opposing second clamp plate adjacent the opposite side of the band saw blade, and wherein during a set operation, the first clamp plate and second clamp plate are moved toward the band saw blade by the mechanical linkage, and clamp the band saw blade between the first clamp plate and the second clamp plate.

10. A setter for setting the teeth of a band saw blade, the band saw blade having multiple teeth on one edge of the blade, the setter having a base member and a mechanical linkage configured to apply a set displacement to at least one tooth of the blade during a set operation, the setter also having a clamping linkage for clamping the band saw blade in the setter during the set operation, the mechanical linkage comprising;
a first pivot on the base member, a first jaw pivotably mounted to the base member on the first pivot and extending to an upper portion above the first pivot and a lower portion below the first pivot, the lower portion having a first cam surface thereon;
a second pivot on the base member, a second jaw pivotably mounted to the base member on the second pivot and extending to an upper portion above the second pivot and a lower portion below the second pivot, the lower portion having a second cam surface thereon;
a third pivot on the base member below the first pivot and below the second pivot, and between the first jaw lower portion and the second jaw lower portion;
a lever member pivotably mounted to the base member on the third pivot, the lever member having a first follower arm extending to one side of the third pivot and a second follower arm extending to the other side of the third pivot, the first follower arm having a first outer surface, and the second follower arm having a second outer surface, the lever member also having a lever handle extending to one side of the third pivot;
at least one up-set tool bit configured to increase the set of the blade tooth, the up-set tool bit being affixed to the upper portion of the first jaw, the distance between the up-set tool bit and the blade tooth being adjustable by a first threaded member;
wherein during the set operation, a rotation of the lever member forces the first outer surface of the first follower arm to contact the first cam surface on the first jaw, and forces the second outer surface of the second follower arm to contact the second cam surface on the second jaw; and
forcing the lower portion of the of the first jaw and the lower portion of the second jaw to rotate outward away form the third pivot, forcing the upper portion of the first jaw and the upper portion of the second jaw to rotate inward toward the band saw blade, and forcing the at least one up-set tool bit to be driven toward the blade tooth of the clamped band saw blade.

11. The setter of claim 10, wherein the distance between the at least one up-set tool bit and the blade tooth is adjusted via the first threaded member such that during the set operation, the up-set tool bit applies a first up-set displacement to the blade tooth.

12. The setter of claim 10, wherein the first outer surface of the first follower arm comprises a bearing rotateably mounted to the first follower arm and the second outer surface of the second follower arm comprises a bearing rotateably mounted to the second follower arm.

13. The setter of claim 10, comprising a wear plate affixed to the first jaw at the first cam surface and a wear plate affixed to the second jaw at the second cam surface.

14. The setter of claim 10, further comprising a spring element which urges the lower portion of the first jaw and the lower portion of the second jaw to rotate inward toward the third pivot.

15. The setter of claim 10, further comprising at least one down-set tool bit configured to decrease the set of the blade tooth, the down-set tool bit being affixed to the upper portion of the second jaw, the distance between the down-set tool bit and the blade tooth being adjustable by a second threaded member; and
wherein the rotation inward of the upper portion of the second jaw toward the band saw blade forces the at least one down-set tool bit to be driven toward the blade tooth of the clamped band saw blade.

16. The setter of claim 15, wherein the distance between the at least one down-set tool bit and the blade tooth is adjusted via the second threaded member such that during the set operation, the down-set tool bit applies a first down-set displacement to the blade tooth.

17. The setter of claim 10, further comprising a second up-set tool bit, configured to increase the set of a second blade tooth of the band saw blade, and a second down-set tool bit, configured to decrease the set of the second blade tooth of the band saw blade during the set operation.

18. The setter of claim 17, wherein the first tooth and the second tooth are adjacent on the band saw blade.

19. The setter of claim 10, wherein the clamping linkage for clamping the band saw blade in the setter comprises a first clamp plate affixed to the first jaw and adjacent one side of the band saw blade and an opposing second clamp plate affixed to the second jaw and adjacent the opposite side of the band saw blade; and
wherein during the set operation, the first clamp plate and second clamp plate are moved toward the band saw blade, and clamp the band saw blade between the first clamp plate and the second clamp plate.

20. A method for setting the teeth of a band saw blade, the band saw blade having multiple teeth on one edge of the blade, the teeth comprising cutting teeth and raker teeth, the method comprising the steps of:
placing the band saw blade in a setter, the setter having a mechanical linkage configured to apply a set displacement to at least one cutting tooth of the blade during a set operation, the setter also having a clamping linkage for clamping the band saw blade in the setter during the set operation;
the setter having at least one up-set tool bit configured to increase the set of the cutting tooth, the distance between the up-set tool bit and the cutting tooth being adjustable by a first threaded member, and the setter having at least one down-set tool bit configured to decrease the set of the cutting tooth, the distance between the down-set tool bit and the cutting tooth being adjustable by a second threaded member;
adjusting the distance between the at least one down-setting tool bit and the cutting tooth via the second threaded member such that during a set operation, the down-set tool bit applies a first down-set displacement to the cutting tooth;
applying a set operation to the blade, wherein the at least one down-set tool bit is driven toward the cutting tooth of the clamped band saw blade and applies the first down-set displacement to the cutting tooth;
rotating the band saw blade within the setter and repeating the set operation until all cutting teeth of the band saw blade receive the first down-set displacement;
adjusting the distance between the at least one down-setting tool bit and the cutting tooth via the second threaded member such that during a set operation, the down-set tool bit does not contact the cutting tooth;
adjusting the distance between the at least one up-setting tool bit and the cutting tooth via the first threaded member such that during a set operation, the up-set tool bit applies a first up-set displacement to the cutting tooth;
applying a set operation to the blade, wherein the at least one up-set tool bit is driven toward the cutting tooth of the clamped band saw blade and applies the first up-set displacement to the cutting tooth;
rotating the band saw blade within the setter and repeating the set operation until all blade cutting teeth receive the first up-set displacement thereby setting the band saw blade.

21. The method of claim 20, wherein the at least one down-set tool bit is comprised of a non-ferrous material.

22. The method of claim 22, wherein the at least one down-set tool bit is comprised of a plastic.

23. The method of claim 20, wherein the setter further comprises a second up-set tool bit, configured to increase the set of a second cutting tooth of the band saw blade, and a second down-set tool bit, configured to decrease the set of the second cutting tooth of the band saw blade during the set operation.

24. A setter for setting the teeth of a band saw blade, the band saw blade having multiple teeth on one edge of the blade, the setter also having a clamping linkage for clamping the band saw blade in the setter during a set operation, the setter further comprising:
at least one up-set tool bit configured to increase the set of a blade tooth, the distance between the up-set tool bit and the blade tooth being adjustable by a first threaded member;
at least one down-set tool bit comprised of a non-ferrous material and configured to decrease the set of the blade tooth, the distance between the down-set tool bit and the blade tooth being adjustable by a second threaded member;
a mechanical linkage configured to move the at least one up-set tool bit toward the blade tooth, and configured to move the at least one down-set tool bit toward the blade tooth during a set operation;
wherein during the set operation, the clamping linkage clamps the blade within the setter, the at least one up-set tool bit is driven toward the blade tooth of the clamped band saw blade by the mechanical linkage, and the at least one down-set tool bit is driven toward the opposing side of the blade tooth of the clamped band saw blade by the mechanical linkage; and
wherein the distance between the at least one up-set tool bit and the blade tooth is adjusted via the first threaded member such that during the set operation, the up-set tool bit applies a first up-set displacement to the blade tooth; and
wherein the distance between the at least one down-setting tool bit and the blade tooth is adjusted via the second threaded member such that during the set operation, the down-set tool bit applies a first down-set displacement to the blade tooth.
